(19) United States
(12) Patent Application Publication
(10) Pub. No.: US 2024/0147064 A1
(43) Pub. Date: May 2, 2024

(54) IMAGING APPARATUS, METHOD FOR CONTROLLING THE SAME, AND STORAGE MEDIUM

(71) Applicant: CANON KABUSHIKI KAISHA, Tokyo (JP)

(72) Inventors: TOSHIYUKI DOBASHI, Kanagawa (JP); RYO KAWASAKI, Kanagawa (JP); NAOKI MARUYAMA, Tokyo (JP)

(21) Appl. No.: 18/493,677

(22) Filed: Oct. 24, 2023

(30) Foreign Application Priority Data
Oct. 31, 2022 (JP) 2022-174744

(51) Int. Cl. H04N 23/67; H04N 23/667; H04N 23/68

(52) U.S. Cl. CPC H04N 23/673; H04N 23/667; H04N 23/6812; H04N 23/683

(57) ABSTRACT

An imaging apparatus controls a focus position of an optical system by switching between a first mode where the focus position is moved alternately to first and second positions to determine an in-focus direction and a second mode where the focus position is moved in the in-focus direction. The apparatus includes an imaging unit that captures an image formed by the optical system, a detection unit that detects a vibration amount of the apparatus, a determination unit that determines, based on the vibration amount, a correction amount for reducing blurring, a correction unit that corrects the blurring by clipping a part of the image based on the correction amount, and a control unit that controls switching to the second mode if the in-focus direction is the same a predetermined number of times or more in succession. The predetermined number is changed based on the correction amount or the vibration amount.

### BACKGROUND OF THE INVENTION

### Field of the Invention

The present invention relates to an imaging apparatus, a method for controlling the imaging apparatus, and a storage medium.

### Description of the Related Art

An automatic focus (AF) function has been known as a focusing function. For example, a contrast AF function (hereafter referred to as contrast AF) generates a high-frequency component of contrast of captured image data and uses the generated frequency component as an AF evaluation value. In this system, focusing can be obtained by adjusting a focus position so that the AF evaluation value is maximized.

The contrast AF performs focusing with two stages of driving, namely, hill-climbing driving and wobbling driving. In the hill-climbing driving, a focus lens is initially driven over a wide range at high speed to detect a rough in-focus position. In the wobbling driving, the focus lens is then finely driven to detect a precise in-focus position.

Depending on the installation environment of an imaging apparatus, image blurring can occur due to vibration. An image stabilization function for correcting the blurring is thus typically used in the imaging apparatus. Some image stabilization functions are known to correct the blurring by shifting a lens or clipping an image based on the amount of vibration of the imaging apparatus acquired from a gyro sensor. If the imaging apparatus is configured to generate the AF evaluation value before the image stabilization, the AF evaluation value can be unstable due to vibration.

Japanese Patent Application Laid-Open No. 2015-166798 discusses a technique for changing a condition for a transition between the wobbling driving and the hill-climbing driving based on the amount of vibration of an imaging apparatus acquired from a gyro sensor.

### SUMMARY OF THE INVENTION

According to an aspect of the present invention, an imaging apparatus configured to control a focus position of an imaging optical system by switching between a first mode where the focus position is moved alternately to a first position and a second position to determine an in-focus direction of the focus position and a second mode where the focus position is moved in the in-focus direction includes an image sensor configured to capture an image of an object formed by the imaging optical system, a sensor configured to detect an amount of vibration of the imaging apparatus, at least one processor, and a memory coupled to the at least one processor, the memory storing instructions that, when executed by the at least one processor, cause the at least one processor to determine, based on the detected amount of vibration, an amount of correction for reducing blurring of the captured image, correct the blurring of the captured image by clipping a part of the captured image based on the amount of correction, determine whether the in-focus direction determined in the first mode is the same a predetermined number of times or more in succession, and switch from the first mode to the second mode in a case where the determined in-focus direction is the same the predetermined number of times or more in succession. The predetermined number of times is changed based on the amount of correction or the detected amount of vibration.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an imaging apparatus according to a first exemplary embodiment.

FIG. 2 is a flowchart illustrating an example of conventional automatic focus (AF) control.

FIGS. 3A to 3F are diagrams illustrating examples of an AF evaluation value and a focus position.

FIG. 4 is a diagram illustrating an example of electronic image stabilization.

FIG. 5 is a flowchart illustrating an example of AF control by the imaging apparatus according to the first exemplary embodiment.

FIG. 6 is a flowchart illustrating an example of AF control by an imaging apparatus according to a second exemplary embodiment.

FIGS. 7A to 7D are diagrams illustrating examples of an AF evaluation value and a focus position of the imaging apparatus according to the second exemplary embodiment.

### DESCRIPTION OF THE EMBODIMENTS

Exemplary embodiments of the present invention will be described in detail below with reference to the attached drawings. The following exemplary embodiments are examples of means for carrying out the present invention, and can be modified or changed as appropriate based on a configuration of an apparatus to which any of the exemplary embodiments is applied and various conditions. The present invention is not limited to the following exemplary embodiments. Parts of the following exemplary embodiments can be combined as appropriate.

### <Apparatus Configuration>

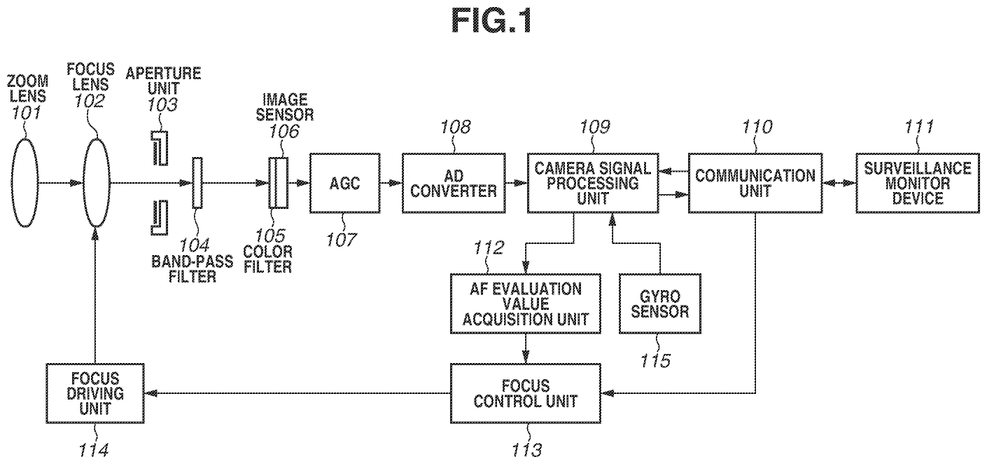

FIG. 1 is a diagram illustrating an example of a configuration of an imaging apparatus 100 according to a first exemplary embodiment. The imaging apparatus 100 includes an imaging optical system including a zoom lens 101, a focus lens 102, and an aperture unit 103. The imaging apparatus 100 also includes a band-pass filter (BPF) 104, a color filter 105, an image sensor 106 (an imaging unit), an auto gain control (AGC) 107, an analog-to-digital (AD) converter 108, a camera signal processing unit 109, a communication unit 110, a surveillance monitor device 111 (a display unit), an automatic focus (AF) evaluation value acquisition unit 112 (an acquisition unit), a focus control unit 113 (a control unit), a focus driving unit 114, and a gyro sensor 115 (a detection unit).

The zoom lens 101 is driven in an optical axis direction to change a focal length. The focus lens 102 is driven in the optical axis direction to change a focus position. The aperture unit 103 is a mechanism for adjusting the amount of light incident on the image sensor 106.

The light having passed through the imaging optical system forms an object image, which is an optical image, on an imaging plane of the image sensor 106 via the BPF 104 and the color filter 105. The BPF 104 is a filter for attenuating light of invisible-light wavelength bands, such as infrared rays, and can be inserted into and removed from the optical path of the imaging optical system.

The image sensor 106 photoelectrically converts the light incident on the imaging plane into an analog electrical signal (an imaging signal) and outputs the analog electrical signal. The AGC 107 amplifies the analog electrical signal generated by the photoelectric conversion, at a predetermined amplification ratio. The amplified imaging signal is converted into a digital signal by the AD converter 108 and output to the camera signal processing unit 109.

The camera signal processing unit 109 (a correction unit) generates a video signal by applying image processing, such as white balance processing and demosaicing processing, to the digital signal. The camera signal processing unit 109 also performs electronic image stabilization (EIS) processing. The EIS processing includes processing of detecting image blurring or the shake of the imaging apparatus 100 based on a motion vector obtained from the video signal or a gyro signal acquired from the gyro sensor 115, and clipping an image to reduce the blurring. In the present exemplary embodiment, the EIS processing is performed based on the gyro signal acquired from the gyro sensor 115.

The video signal is output to the surveillance monitor device 111 that is connected to the imaging apparatus 100 by wired or wireless communication via the communication unit 110.

The communication unit 110 receives instruction information from an external information processing apparatus (e.g., a personal computer (PC) or a tablet terminal) via a network, and outputs a control signal to the camera signal processing unit 109 in the imaging apparatus 100. For example, the EIS processing can be changed from the external information processing apparatus. The communication unit 110 also receives manual focus (MF) instruction information from the external information processing apparatus, and outputs a control signal to the focus control unit 113 to control the focus position.

The AF evaluation value acquisition unit 112 acquires an AF evaluation value indicating the degree of contrast at a specific frequency based on the video signal output from the camera signal processing unit 109. A value indicating the degree of contrast of a high-frequency component among the spatial frequencies of the video signal is acquired as the AF evaluation value. The AF evaluation value is acquired by calculating the degree of contrast (e.g., a difference in luminance) of the high-frequency component of the video signal. In the present exemplary embodiment, the AF evaluation value is acquired based on the video signal prior to execution of the EIS processing.

During an AF operation, the focus control unit 113 performs AF control based on the AF evaluation value acquired by the AF evaluation value acquisition unit 112. During an MF operation, the focus control unit 113 performs focus control based on the instruction information received via the communication unit 110. The external information processing apparatus receives instructions from the user and outputs the instruction information, whereby the instruction information is transmitted to the communication unit 110. The AF and MF operations are switched also based on the instruction information received externally via the communication unit 110.

The focus driving unit 114 controls the focus lens 102 to be positioned according to an instruction from the focus control unit 113.

### <Conventional AF Control>

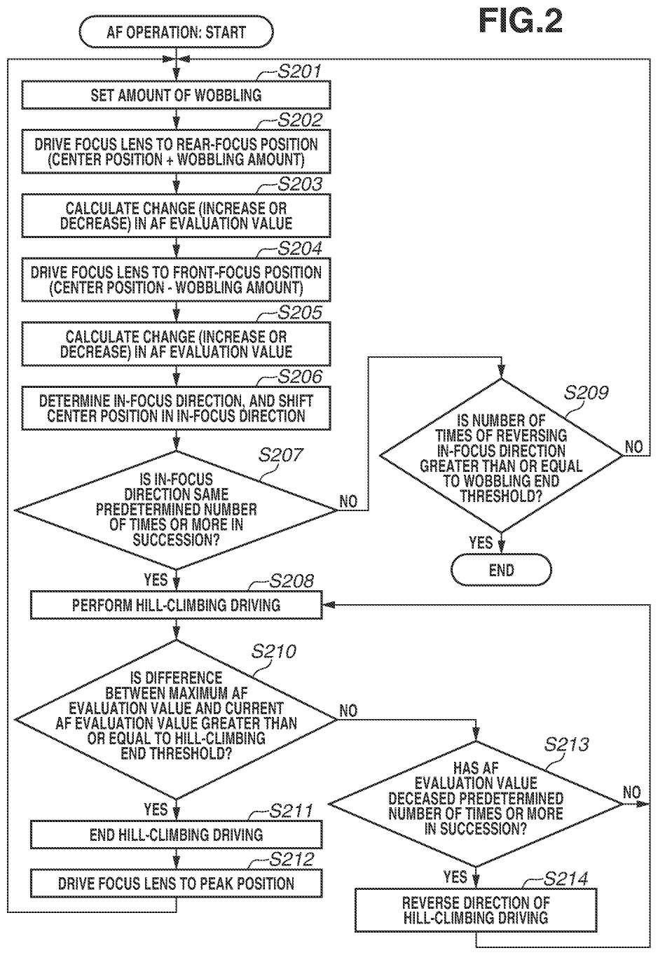

FIG. 2 is a flowchart illustrating an example of conventional AF control. After start of the AF control, wobbling driving (a first mode) is initially performed. In the wobbling driving, the focus lens 102 is slightly driven to compare AF evaluation values before and after the driving and determine an in-focus direction based on a relationship in magnitude between the AF evaluation values. The focus lens 102 is then gradually driven in the determined in-focus direction. The AF control illustrated in FIG. 2 is performed by a not-illustrated central processing unit (CPU) of the imaging apparatus 100 loading an AF control program stored in a storage medium.

In step S201, the focus control unit 113 sets the amount of wobbling depending on the depth. The amount of wobbling is typically set within one depth level to make defocusing due to the wobbling driving less noticeable. This, however, is not necessarily the case if the focus position is not close to an in-focus position.

In step S202, the focus control unit 113 drives the focus lens 102 to a rear-focus position (a first position). In step S203, the focus control unit 113 calculates a change in the AF evaluation value (whether the AF evaluation value increases or decreases) due to the rear-focus driving. The rear-focus position is obtained by adding the amount of wobbling to a wobbling center position (which is initially the current focus position).

In step S204, the focus control unit 113 drives the focus lens 102 to a front-focus position (a second position). In step S205, the focus control unit 113 calculates a change in the AF evaluation value (whether the AF evaluation value increases or decreases) due to the front-focus driving. The front-focus position is obtained by subtracting the amount of wobbling from the wobbling center position.

In step S206, the focus control unit 113 determines the in-focus direction based on the change in the AF evaluation value at the rear-focus position, which is calculated in step S203, and the change in the AF evaluation value at the front-focus position, which is calculated in step S205. If the AF evaluation value increases at the front-focus position and decreases at the rear-focus position, the front-focus direction is determined to be the in-focus direction. If the AF evaluation value decreases at the front-focus position and increases at the rear-focus position, the rear-focus direction is determined to be the in-focus direction. The focus control unit 113 then controls the position of the focus lens 102 so that the wobbling center position is shifted in the direction determined to be the in-focus direction in step S206.

In such a manner, the focus control unit 113 performs the wobbling driving (the first mode) of moving the focus position of the imaging optical system alternately to the first position and the second position to determine the in-focus direction of the focus position.

In step S207, the focus control unit 113 determines whether the in-focus direction is the same a predetermined number of times or more in succession. If the in-focus direction is the same the predetermined number of times or more in succession (YES in step S207), the processing proceeds to step S208. In step S208, the focus control unit 113 transitions to hill-climbing driving. If the in-focus direction is not the same the predetermined number of times or more in succession (NO in step S207), the processing proceeds to step S209. In step S209, the focus control unit 113 determines whether the number of times of reversing the in-focus direction is greater than or equal to a wobbling end threshold (a first threshold). If the number of times of reversing the in-focus direction is less than the wobbling end threshold (NO in step S209), the processing returns to step S201 to continue the wobbling driving. If the number of times of reversing the in-focus direction is greater than or equal to the wobbling end threshold (YES in step S209), the focus control unit 113 determines that the in-focus position has been reached, and ends the AF control. If, in step S206, the changes in the AF evaluation value are the same, the focus control unit 113 also determines that the in-focus position has been reached, and ends the AF control.

In step S208, the focus control unit 113 performs the hill-climbing driving (a second mode). More specifically, the focus control unit 113 drives the focus lens 102 in the in-focus direction at high speed and detects the focus position (the peak position) where the AF evaluation value is maximized. During the hill-climbing driving, the maximum value of the AF evaluation value and the focus position where the maximum value is obtained are stored in a not-illustrated storage unit, such as a random access memory (RAM). In step S210, the focus control unit 113 determines whether a difference between the stored maximum value and the current AF evaluation value is greater than or equal to a hill-climbing end threshold (a second threshold). If the difference is greater than or equal to the hill-climbing end threshold (YES in step S210), the processing proceeds to step S211. In step S211, the focus control unit 113 ends the hill-climbing driving and detects the stored focus position as the peak position. In step S212, the focus control unit 113 drives the focus lens 102 to the peak position. The processing then returns to step S201.

If the hill-climbing driving is not to be ended (NO in step S210), the processing proceeds to step S213. In step S213, the focus control unit 113 determines whether the AF evaluation value has decreased a predetermined number of times or more in succession. If the AF evaluation value is determined to have decreased the predetermined number of times or more in succession (YES in step S213), the processing proceeds to step S214. In step S214, the focus control unit 113 determines that the focus lens 102 is driven in a direction reverse to the in-focus direction, and reverses the direction of the hill-climbing driving.

In such a manner, the focus control unit 113 performs the hill-climbing driving (the second mode) of moving the focus position of the imaging optical system in the in-focus direction. In addition, the focus control unit 113 controls the focus position of the imaging optical system to be at the in-focus position by switching between the first and second modes.

### <Vibration of Imaging Apparatus and AF Evaluation Value>

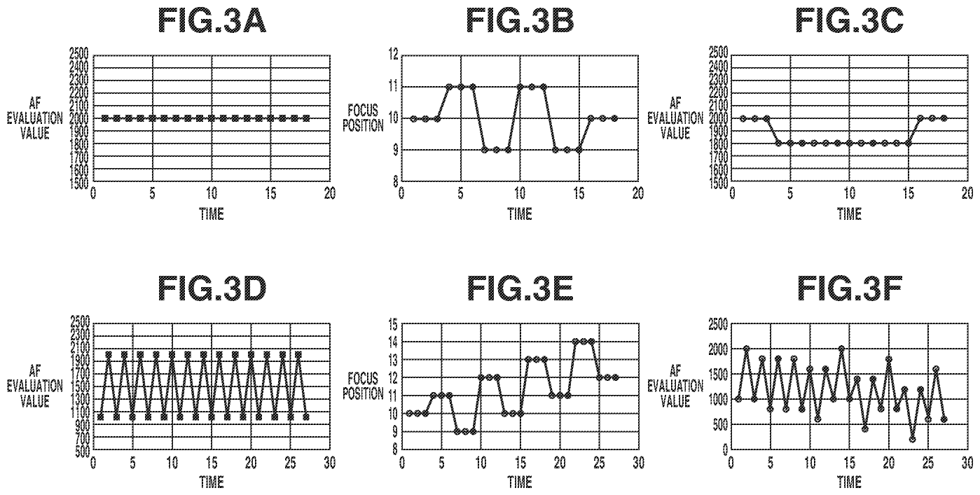

FIGS. 3A to 3F are graphs illustrating a relationship among the vibration of the imaging apparatus 100, the AF evaluation value, and the focus position. FIG. 3A illustrates an example of the AF evaluation value in an in-focus state in a case where the imaging apparatus 100 does not vibrate (or vibrates slightly) and the object has no change (or a slight change). FIGS. 3B and 3C illustrate the focus position and the AF evaluation value, respectively, in a case where the wobbling driving by the AF operation is performed in the environment indicated by FIG. 3A.

FIG. 3D illustrates an example of the AF evaluation value in the in-focus state in a case where the imaging apparatus 100 vibrates and the object has no change (or a slight change). FIGS. 3E and 3F illustrate the focus position and the AF evaluation value, respectively, in a case where the wobbling driving by the AF operation is performed in the environment indicated by FIG. 3D.

Suppose that a focus position (a center position) of 10 in FIGS. 3B and 3E is the position of the in-focus state, and the amount of wobbling is 1. The horizontal axis in each of the graphs of FIGS. 3A to 3F indicates time in units of frames. The AF evaluation value is acquired after waiting for two frames after the driving of the focus lens 102. In FIGS. 3C and 3F, the AF evaluation value is acquired at timing indicated by each black circle marker.

In FIG. 3B, the wobbling driving is performed by repeatedly moving the focus position to a rear-focus position of 11 and a front-focus position of 9 with respect to the center position of 10. FIG. 3C illustrates the resulting AF evaluation value. Because the AF evaluation value is the same between when the focus position is moved to the rear-focus position of 11 and when the focus position is moved to the front-focus position of 9 in FIG. 3B, the AF operation ends without moving the center position. In other words, the focus position of 10 in the in-focus state is maintained.

By contrast, if, in FIG. 3E, the wobbling driving is performed to move the focus position to the rear-focus position of 11 and the front-focus position of 9 with respect to the center position of 10, the AF evaluation value illustrated in FIG. 3F increases at the rear-focus position of 11 and decreases at the front-focus position of 9. The center position is thus moved to a position of 11 in the rear-focus direction. Similarly, if the wobbling driving is performed to move the focus position to the rear-focus position of 12 and the front-focus position of 10 with respect to the center position of 11, the center position is further moved in the rear-focus direction. The focus position thus moves gradually in the rear-focus direction.

Suppose that the predetermined number of times in step S207 is three. In such a case, the focus control unit 113 transitions to the hill-climbing driving to move the focus position largely, and blurring on the image becomes conspicuous.

### <EIS Processing>

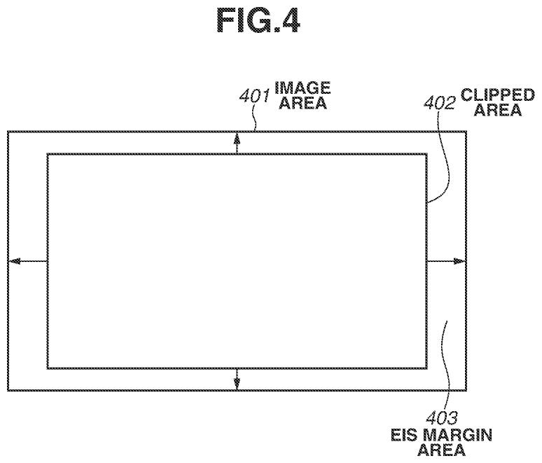

The EIS processing according to the present exemplary embodiment will be described with reference to FIG. 4. FIG. 4 is a diagram illustrating a position of a clipped area 402 (a clipping position) in an image area 401. The image area 401 is the area of the image data generated by the imaging processing of the image sensor 106. The clipped area 402 is a part of the image area 401 that is clipped to leave an EIS margin area 403 by image processing, such as electronic zooming. In the EIS processing, the amount of correction of the clipping position for reducing image blurring is calculated based on the amount of vibration of the imaging apparatus 100 detected by the gyro sensor 115. If the detected amount of vibration is less than a predetermined value, the amount of correction is 0 and the clipped area 402 is located at the center of the image area 401. If the detected amount of vibration is greater than or equal to the predetermined value, the clipped area 402 is shifted by the amount of correction corresponding to the detected amount of vibration. Arrows in FIG. 4 indicate the directions in which the correction can be made. The direction of correcting the clipping position is calculated based on the direction of vibration of the imaging apparatus 100 detected by the gyro sensor 115. Image blurring can be reduced by making the direction of the correction, for example, opposite to the direction in which the image blurring occurs.

Further, in the EIS processing according to the present exemplary embodiment, the amount of correction of the clipping position is calculated based on a zoom position. The reason is that, even if the amounts of vibration acquired from the gyro sensor 115 before and after change of the zoom position are the same, the blurring on the image appears different depending on the zoom position.

With the same amount of vibration, the blurring on the image is smaller on the wide-angle side and larger on the telephoto side. The amount of correction of the clipping position is thus calculated to be smaller on the wide-angle side and larger on the telephoto side. The amount of correction can be calculated by obtaining a table listing the amounts of corrections corresponding to respective zoom positions in advance based on the lens optical characteristics.

In such a manner, the amount and direction of correction for reducing image blurring are determined based on the amount of vibration detected by the detection unit, such as the gyro sensor 115. The amount of correction is determined by the camera signal processing unit 109 (a determination unit).

The amount of correction calculated in the EIS processing is output to the focus control unit 113 via the communication unit 110 (or directly).

### <AF Control>

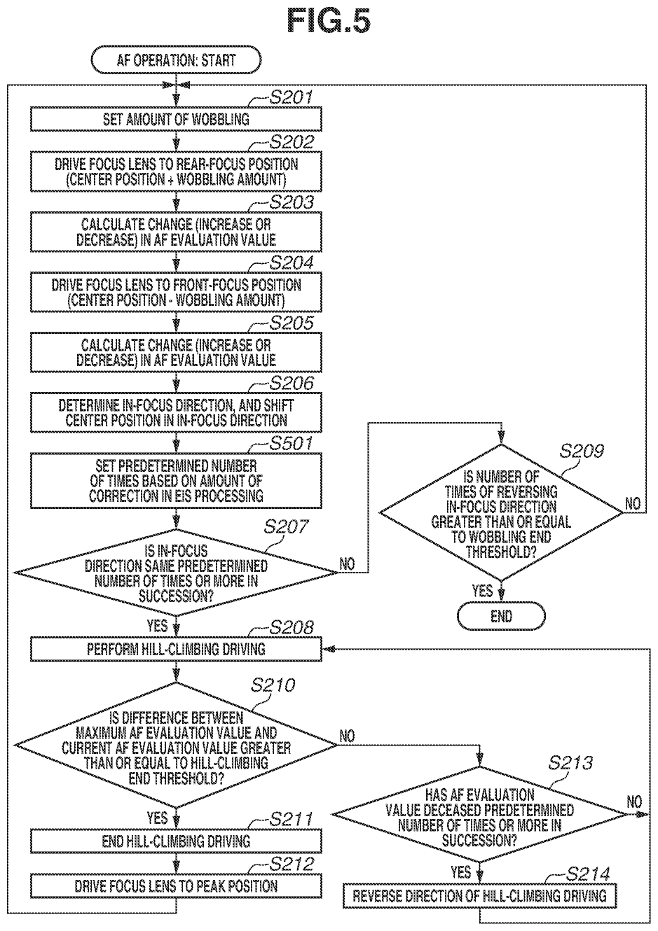

FIG. 5 is a flowchart illustrating an example of an operation of AF control according to the present exemplary embodiment. Steps similar to those in the description of the conventional AF control in FIG. 2 are denoted by the same step numbers, and a description thereof will be omitted. The AF control according to the present exemplary embodiment is intended to change the condition for switching from the wobbling driving (the first mode) to the hill-climbing driving (the second mode), based on the amount of correction of the clipping position in the EIS processing. The operation of the AF control according to the present exemplary embodiment is a function performed by software included in the configuration of the imaging apparatus 100 illustrated in FIG. 1, and implemented by the not-illustrated CPU reading a program.

In step S501, the focus control unit 113 sets a predetermined number of times to be used to determine whether to transition to the hill-climbing driving in step S207, based on the amount of correction of the clipping position in the EIS processing. The predetermined number of times is set to be larger in a case where the amount of correction is greater than or equal to a predetermined value than in a case where the amount of correction is less than the predetermined value. In other words, if the amount of correction is determined to be greater than or equal to the predetermined value, the predetermined number of times is changed and increased. In the present exemplary embodiment, the predetermined number of times is set to 8 if the amount of correction is less than the predetermined value. The predetermined number of times is set to 16 if the amount of correction is greater than or equal to the predetermined value. In other words, the larger the detected amount of vibration (or the blurring on the image) is, the less likely the wobbling driving is to transition to the hill-climbing driving.

In the present exemplary embodiment, the predetermined number of times is described to be changed based on the amount of correction in the EIS processing. However, the predetermined number of times may be changed based on the amount of vibration detected by the gyro sensor 115. For example, the predetermined number of times is changed and increased if the detected amount of vibration is greater than or equal to a predetermined value.

Since an erroneous transition to the hill-climbing driving due to vibration can thereby be reduced, an imaging apparatus capable of performing a more stable AF operation in a vibrating environment can be provided.

In a second exemplary embodiment, the effect of the vibration can further be reduced by averaging AF evaluation values in addition to the first exemplary embodiment. An imaging apparatus according to the present exemplary embodiment has a similar configuration to that in the first exemplary embodiment. A description thereof will thus be omitted.

### <AF Control>

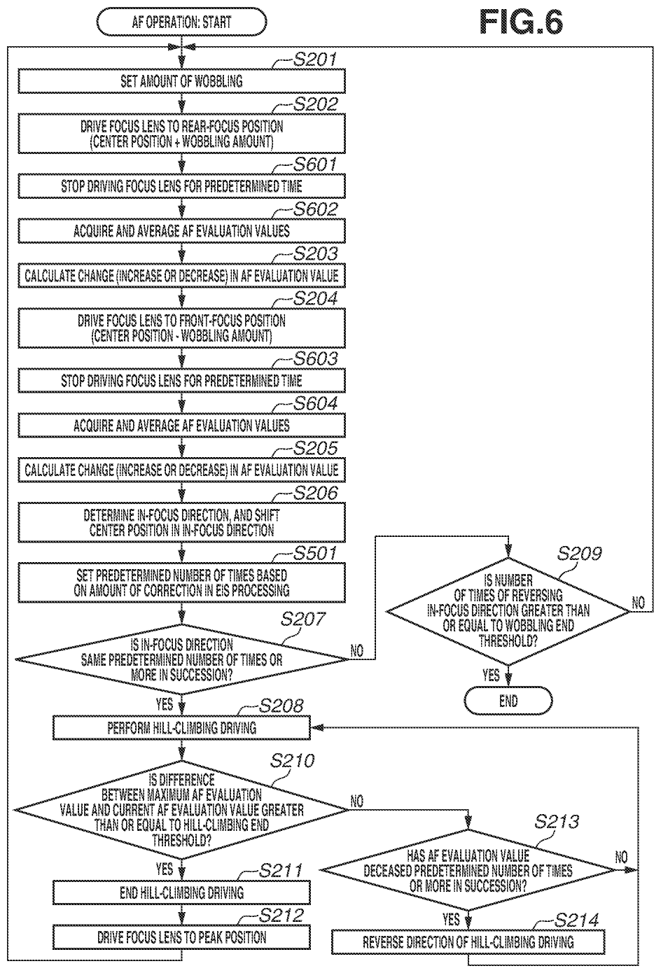

FIG. 6 is a flowchart illustrating an operation of AF control according to the present exemplary embodiment. In the present exemplary embodiment, processing similar to that in the first exemplary embodiment is denoted by the same step numbers as those in FIG. 2 (FIG. 5). A detailed description thereof will be omitted.

In step S601, after the focus lens 102 is driven to the rear-focus position (the first position) in step S202, the focus control unit 113 stops driving the focus lens 102 for a predetermined time. The predetermined time, i.e., the stop time is changed based on the averaging time in the subsequent step S602.

In step S602, the focus control unit 113 acquires the AF evaluation values a plurality of times during the temporary stop in step S601, and averages the acquired AF evaluation values. The average evaluation value is used in the subsequent step S203.

In step S603, after the focus lens 102 is driven to the front-focus position (the second position) in step S204, the focus control unit 113 stops driving the focus lens 102 for a predetermined time. The stop time is changed based on the averaging time in the subsequent step S604.

In step S604, the focus control unit 113 acquires the AF evaluation values a plurality of times during the temporary stop in step S603, and averages the acquired AF evaluation values. The average evaluation value is used in step S205. In such a manner, the average of the plurality of AF evaluation values is acquired at each of the front-focus position and the rear-focus position.

The number of acquired AF evaluation values and the number of AF evaluation values used for averaging may not necessarily be the same. For example, the AF evaluation values may be acquired from four frames while the focus lens 102 is stopped, and the AF evaluation values from three of the four frames may be averaged and used in step S203 (S205). In other words, the number of acquired AF evaluation values may be larger than the number of AF evaluation values used for averaging. In this case, the AF evaluation values used for averaging are desirably those acquired from consecutive frames immediately before the resumption of the driving of the focus lens 102.

### <AF Evaluation Value and Focus Position>

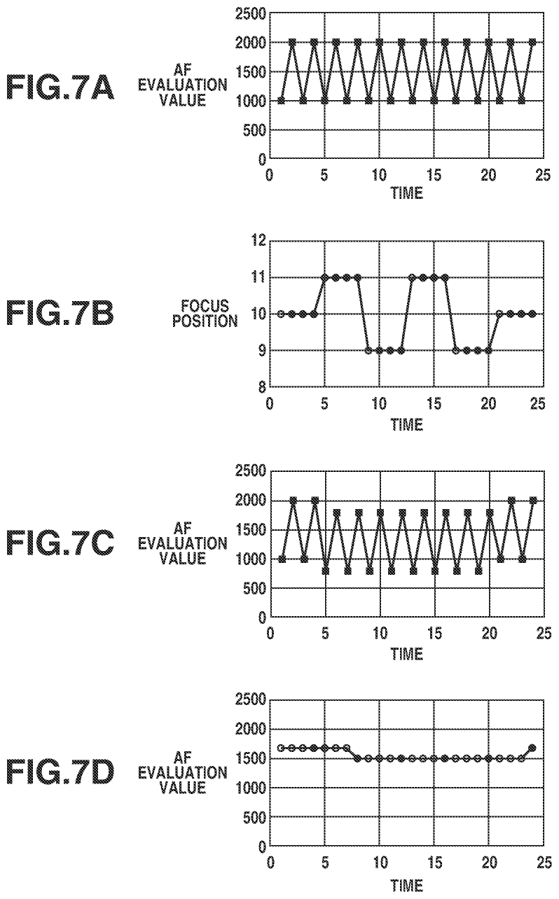

FIGS. 7A to 7D are graphs illustrating examples of the AF evaluation value and the focus position during the wobbling driving according to the present exemplary embodiment. FIG. 7A illustrates the AF evaluation value in the in-focus state in a case where the imaging apparatus 100 vibrates (the gyro sensor 115 detects the vibration) and the object has no change (or a slight change). FIG. 7B illustrates the focus position in a case where the wobbling driving by the AF control according to the present exemplary embodiment is performed in the environment indicated by FIG. 7A. FIGS. 7C and 7D illustrate the AF evaluation values acquired without and with averaging, respectively, during the wobbling driving.

The present exemplary embodiment deals with a case where the AF evaluation values from three frames are averaged. Unlike the first exemplary embodiment, the stop time is four frames. The AF evaluation values are acquired at points indicated by black circles in FIG. 7B. The AF evaluation values may be averaged in real time during the acquisition, or averaged at a time every three frames. The time to stop the focus lens 102, i.e., the stop time can be changed based on time related to the driving of the imaging optical system (the focus lens 102) and/or the number of frames for averaging. For example, the time corresponding to the number of frames for averaging is set as the stop time.

In acquiring the changes in the AF evaluation value in steps S203 and S205, the AF evaluation values at points indicated by black circles in FIG. 7D are used. As can be seen from a comparison of FIGS. 7C and 7D, the effect of the vibration on the AF evaluation values is reduced by averaging the AF evaluation values. An imaging apparatus capable of performing a more stable AF operation in a vibrating environment can thus be provided.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-174744, filed Oct. 31, 2022, which is hereby incorporated by reference herein in its entirety.

What is claimed is:

1. An imaging apparatus configured to control a focus position of an imaging optical system by switching between a first mode where the focus position is moved alternately to a first position and a second position to determine an in-focus direction of the focus position and a second mode where the focus position is moved in the in-focus direction, the imaging apparatus comprising:
an image sensor configured to capture an image of an object formed by the imaging optical system;
a sensor configured to detect an amount of vibration of the imaging apparatus;
at least one processor; and
a memory coupled to the at least one processor, the memory storing instructions that, when executed by the at least one processor, cause the at least one processor to:
determine, based on the detected amount of vibration, an amount of correction for reducing blurring of the captured image,
correct the blurring of the captured image by clipping a part of the captured image based on the amount of correction,
determine whether the in-focus direction determined in the first mode is the same a predetermined number of times or more in succession, and
switch from the first mode to the second mode in a case where the determined in-focus direction is the same the predetermined number of times or more in succession,
wherein the predetermined number of times is changed based on the amount of correction or the detected amount of vibration.

2. The imaging apparatus according to claim 1, wherein the instructions further cause the at least one processor to acquire an average of a plurality of evaluation values at each of the first position and the second position in the first mode, wherein the plurality of evaluation values each indicates contrast of the captured image.

3. The imaging apparatus according to claim 1, wherein, in a case where the amount of correction is greater than or equal to a predetermined value or the amount of vibration is greater than or equal to a predetermined value, the predetermined number of times is increased.

4. The imaging apparatus according to claim 1, wherein the amount of correction is determined based on a zoom position of the imaging optical system.

5. A method for controlling an imaging apparatus configured to control a focus position of an imaging optical system by switching between a first mode where the focus position is moved alternately to a first position and a second position to determine an in-focus direction of the focus position and a second mode where the focus position is moved in the in-focus direction, the method comprising:
capturing an image of an object formed by the imaging optical system;
detecting an amount of vibration of the imaging apparatus;
determining, based on the detected amount of vibration, an amount of correction for reducing blurring of the captured image;
correcting the blurring of the captured image by clipping a part of the captured image based on the amount of correction;
determining whether the in-focus direction determined in the first mode is the same a predetermined number of times or more in succession; and
switching from the first mode to the second mode in a case where the determined in-focus direction is the same the predetermined number of times or more in succession,
wherein the predetermined number of times is changed based on the amount of correction or the detected amount of vibration.

6. The method according to claim 5, further comprising acquiring an average of a plurality of evaluation values at each of the first position and the second position in the first mode, wherein the plurality of evaluation values each indicates contrast of the captured image.

7. The method according to claim 5, wherein, in a case where the amount of correction is greater than or equal to a predetermined value or the amount of vibration is greater than or equal to a predetermined value, the predetermined number of times is increased.

8. The method according to claim 5, wherein the amount of correction is determined based on a zoom position of the imaging optical system.

9. A non-transitory computer-readable storage medium storing a program for performing the method according to claim 5.
